(19) United States
(12) Patent Application Publication
(10) Pub. No.: US 2026/0079654 A1
(43) Pub. Date: Mar. 19, 2026

(54) STORAGE MEDIUM STORING APPLICATION PROGRAM, INFORMATION PROCESSING APPARATUS, AND CONTROL METHOD

(71) Applicant: CANON KABUSHIKI KAISHA, Tokyo (JP)

(72) Inventor: KENTA MATSUI, Ibaraki (JP)

(21) Appl. No.: 19/321,645

(22) Filed: Sep. 8, 2025

(30) Foreign Application Priority Data
Sep. 18, 2024 (JP) 2024-160613

(51) Int. Cl. G06F 3/12

(52) U.S. Cl. CPC G06F 3/1206; G06F 3/1205; G06F 3/1232; G06F 3/1244; G06F 3/1253; G06F 3/1287

(57) ABSTRACT

A non-transitory computer-readable storage medium storing an application program supporting a standard driver that is provided from a provider of an operating system and is incorporated in the operating system in advance. The application program causes a computer to display a setting reception screen for receiving a setting of a format of the print data, and cause the standard driver to generate the print data, with the setting of the format, which has been received on the setting reception screen.

### BACKGROUND

### Field of the Technology

The present disclosure relates to a storage medium storing an application program, an information processing apparatus, and a control method.

### Description of the Related Art

As a standard protocol of the printing industry, the Internet Printing Protocol (IPP) is used. Further, a printer driver (hereinafter referred to as the “local printer driver”) that directly communicates with an image forming apparatus, such as a printing apparatus, using this IPP is widely used. The local printer driver is a printer driver that is provided by a vendor (manufacturer) providing an operating system (OS) and generates print data which can be interpreted by printers of a plurality of printer vendors. A user can transmit, by using the local printer driver incorporated in an information processing apparatus, such as a personal computer, print data to an image forming apparatus without installing a printer driver specific to a printer vendor in the information processing apparatus. Further, there is a printing method using a cloud print service. In the cloud print service, a printer driver for the cloud print service (hereinafter referred to as the “cloud printer driver”) is installed in an information processing apparatus. The cloud printer driver is a printer driver that communicates with an image forming apparatus via the cloud print service by using IPP. Further, similar to the local printer driver, the cloud printer driver is also a printer driver that is provided by a vendor providing an OS and generates print data which can be interpreted by the printers of the plurality of printer vendors. A user can transmit print data to an image forming apparatus via the cloud print service by using the cloud printer driver incorporated in an information processing apparatus. Japanese Laid-Open Patent Publication No. 2021-33526 discloses a technique for generating, in printing using the cloud print service (server system), print data according to an application incorporated in an information processing apparatus and transmitting the generated print data to an image forming apparatus.

There is a case where, for example, depending on a type of print data received by the image forming apparatus, a user desires to change the format of the print data to a vector format or a raster format. However, Japanese Laid-Open Patent Publication No. 2021-33526 discloses that the print data format can be set to the raster format but does not disclose whether or not the print data format can be set to the vector format.

### SUMMARY

The present disclosure is directed to providing a mechanism that makes it possible to set a print data format as desired.

In a first aspect of the present disclosure, there is provided a non-transitory computer-readable storage medium storing an application program supporting a standard driver that is provided from a provider of an operating system and is incorporated in the operating system in advance, the application program causing a computer to display a setting reception screen for receiving a setting of a format of print data, and cause the standard driver to generate the print data, with the setting of the format, which has been received on the setting reception screen.

In a second aspect of the present disclosure, there is provided an information processing apparatus including a standard driver that is provided from a provider of an operating system and is incorporated in the operating system in advance, and an application program supporting the standard driver, the application program causing a computer of the information processing apparatus to display a setting reception screen for receiving a setting of a format of print data, and cause the standard driver to generate the print data, with the setting of the format, which has been received on the setting reception screen.

Features of the present disclosure will become apparent from the following description of embodiments with reference to the attached drawings. The following description of embodiments are described by way of example.

### BRIEF DESCRIPTION OF THE DRAWINGS

FIG. 1 is a block diagram showing an example of a schematic configuration of a printing system according to a first embodiment.

FIGS. 2A to 2D are block diagrams showing examples of hardware configurations of the printing system.

FIG. 3A is a sequence diagram showing a process executed between a client terminal, a cloud print server, and a printer.

FIGS. 3B-A and 3B-B are diagrams showing a capabilities information request (Get-Printer-Attributes) provided in a step S302 of the sequence diagram shown in FIG. 3A and IPP attribute information of a capabilities information response transmitted in a step S303 in response to the request, respectively.

FIG. 4 is a flowchart showing details of processing operations in a step S314 and a step S315 of the sequence diagram shown in FIG. 3A.

FIGS. 5A to 5C are diagrams each showing an example of a screen displayed on the client terminal.

FIG. 6A is a flowchart of a process executed by the client terminal.

FIG. 6B is a flowchart of a process executed by the printer.

FIGS. 7A and 7B are diagrams each showing an example of a screen displayed on the client terminal according to a second embodiment.

### DESCRIPTION OF THE EMBODIMENTS

The present disclosure will now be described in detail below with reference to the accompanying drawings showing embodiments thereof. Configurations described in the following embodiments are given, only by way of example, and are by no means intended to limit the scope of the present disclosure. For example, components of the configurations of the present disclosure can be replaced with desired components which can exhibit the same functions. Further, desired components can be added. Further, two or more desired components (features) of the embodiments can be combined.

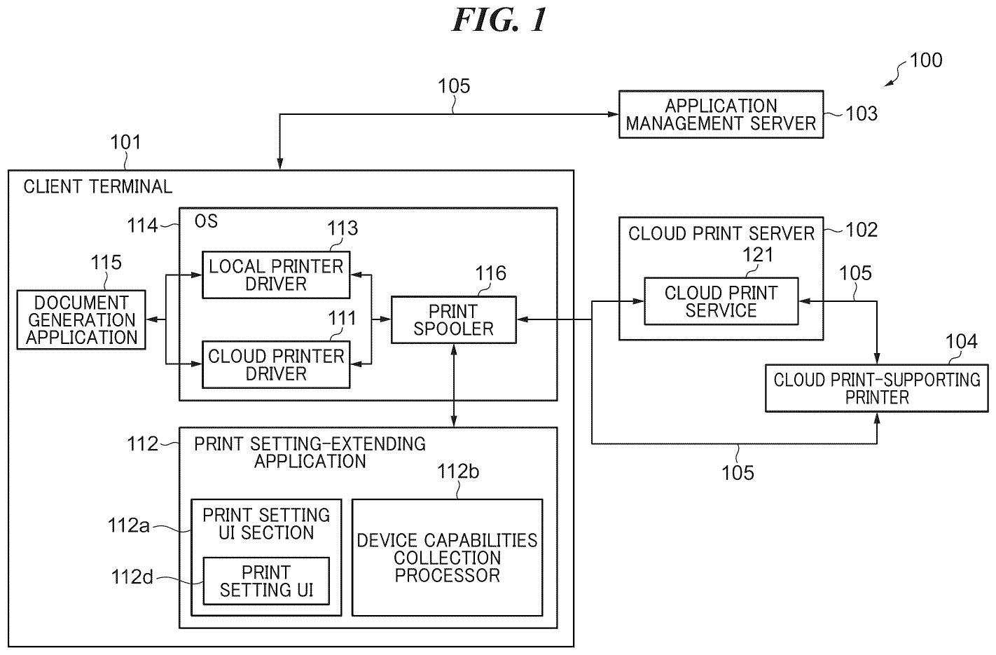

A first embodiment will be described below with reference to FIGS. 1 to 6B. FIG. 1 is a block diagram showing an example of a schematic configuration of a printing system according to the first embodiment. As shown in FIG. 1, the printing system, denoted by reference numeral 100, includes a client terminal 101, a cloud print server 102, an application management server 103, and a cloud print-supporting printer (hereinafter simply referred to as the “printer”) 104. These apparatuses included in the printing system 100 are communicably connected to each other via a network 105. Note that although in the configuration shown in FIG. 1, one client terminal 101 and one printer 104 are disposed, the numbers of disposed apparatuses are not limited to these. For example, the client terminal 101 and the printer 104 can be provided in plurality, respectively. Further, each of the cloud print server 102 and the application management server 103 can be configured as one information processing apparatus or as a plurality of information processing apparatuses. In a case where the cloud print server 102 and the application management server 103 are each formed by a plurality of information processing apparatuses, processing operations can be distributed among the information processing apparatuses. Further, the cloud print server 102 can be a virtual server. The network 105 is a wide area network (WAN), such as the Internet, but is not limited to this, and for example, the network 105 can be a local area network (LAN), for example.

The client terminal 101 is an information processing apparatus, such as a desktop-type or laptop-type personal computer, a tablet terminal, or a smartphone. As shown in FIG. 1, the client termina 101 has a print setting-extending application (application program) 112, an OS 114, and a document generation application 115. In the OS 114, a cloud printer driver 111, a local printer driver 113, and a print spooler 116 are incorporated in advance. Further, the cloud printer driver 111 and the local printer driver 113 are each a standard driver provided by the provider of the OS 114. The standard driver is a class driver (general-purpose program) which can be commonly used for printers (including the printer 104) of a plurality of makers e.g. when printing is performed. The standard driver is provided along with the OS 114 as one of functions in the package of the OS 114. The standard driver can perform processing for various types of printers by using a standardized printing method. With this, the standard driver can generate and output an instruction which can be interpreted by the printers of the plurality of makers. Note that the standard driver is not particularly limited, and, for example, a program operating based on the IPP is used.

The local printer driver 113 is a printer driver used when the client terminal 101 and the printer 104 are connected, not via a cloud print service 121 of the cloud print server 102. The cloud printer driver 111 is a printer driver used when the client terminal 101 and the printer 104 are connected via the cloud print service 121. In this case, it is possible to use the cloud print service 121. In the cloud print service 121, information of the printer 104 is registered in advance. The client terminal 101 designates the printer 104 as an output destination of print data generated by the cloud printer driver 111 and transmits this print data to the cloud print service 121. In the cloud print service 121, by transmitting print data to the printer 104, printing of the print data is executed by the printer 104. The print spooler 116 is a function related to printing, which is provided by the OS 114. The print spooler 116 has a function of temporarily storing intermediate data and print data output from the cloud printer driver 111 or the local printer driver 113. The temporarily stored print data is called by the print setting-extending application 112, or is transmitted to the cloud print server 102 or the printer 104.

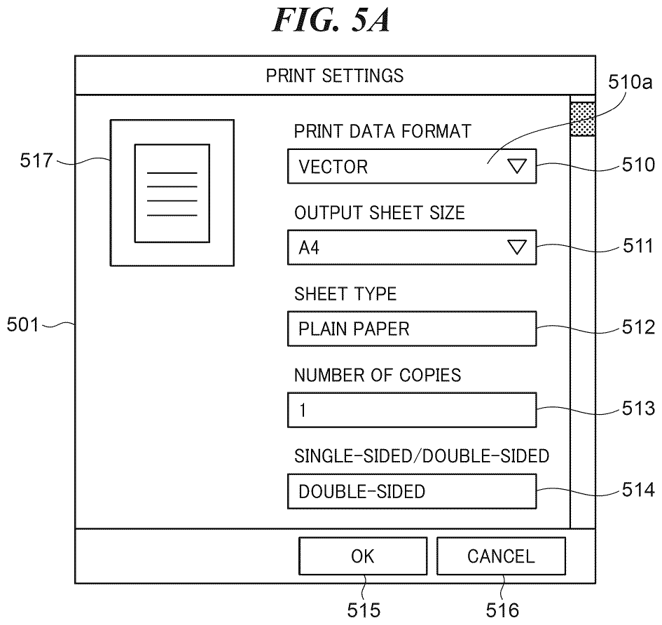

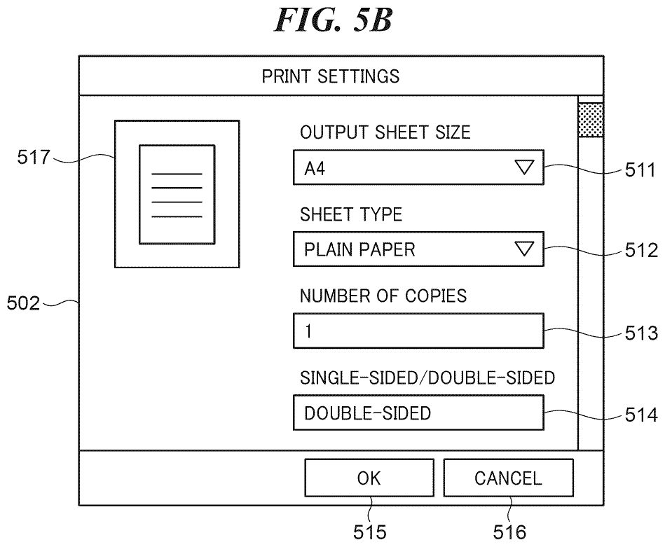

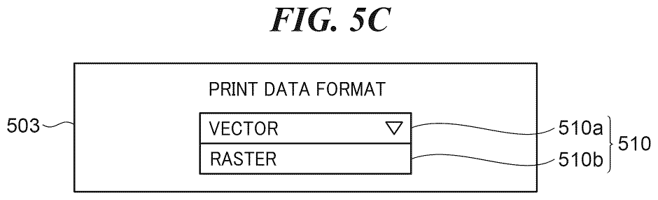

The print setting-extending application 112 is a program supporting the cloud printer driver 111 and the local printer driver 113, i.e. the standard drivers via the print spooler 116. Specifically, the print setting-extending application 112 is an extension program that extends functions related to print settings of the standard driver. The print setting-extending application 112 is provided e.g. from one of the plurality of makers. Note that although in the present embodiment, the print setting-extending application 112 is in a state stored in a storage section (storage medium) 214 of the client terminal 101 when the client terminal 101 is shipped, this is not limitative. For example, in a case where the print setting-extending application 112 is not stored in the storage section 214 when the client terminal 101 is shipped, the print setting-extending application 112 is downloaded from the application management server 103 into the storage section 214 via the network 105. The print setting-extending application 112 has a print setting user interface (UI) section 112a and a device capabilities collection processor 112b. The print setting UI section 112a provides a print setting UI 112d which is a setting reception screen which can receive a variety of settings, to a user. The print setting UI section 112a generates and displays the print setting UI 112d based on capabilities information acquired by the OS 114 and the print setting-extending application 112 from the cloud print service 121. The capabilities information refers to information related to capabilities of the printer 104 for printing. The print setting UI 112d will be described hereinafter with reference to FIGS. 5A to 5C. The device capabilities collection processor 112b is a module for collecting the capabilities information of the printer 104 by operating the OS 114, and updating device capabilities information managed by the OS 114, based on the collected capabilities information.

The document generation application 115 is a variety of applications, such as an application for generating a document file, an application for performing spreadsheet operations, and an application for generating a presentation. The document generation application 115 can be pre-installed in the OS 114 or can be downloaded and installed.

The cloud print server 102 is a server apparatus for providing the cloud print service 121 from the provider of the OS 114. In the present embodiment, the cloud print server 102 receives a print instruction and print data from the client terminal 101. The cloud print server 102 can provide the cloud print service 121 to a user by transmitting the received print data to the printer 104. The printer 104 is an image forming apparatus that converts the print data received from the client terminal 101 to image data and performs printing on a recording medium, such as a print sheet. The printer 104 is not particularly limited, and for example, a multi-function peripheral (MFP) or a single function peripheral (SFP) can be used.

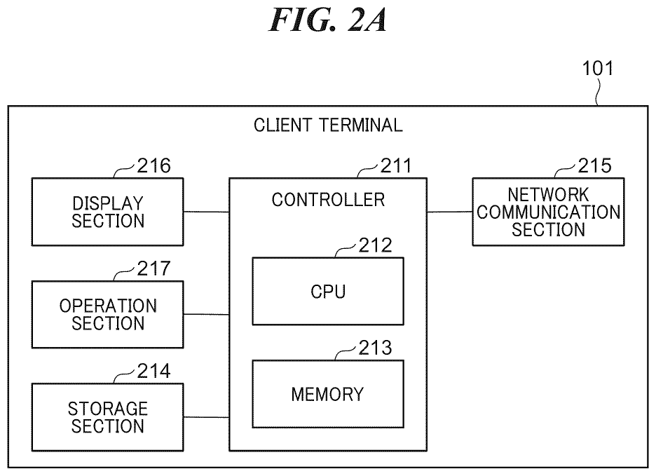

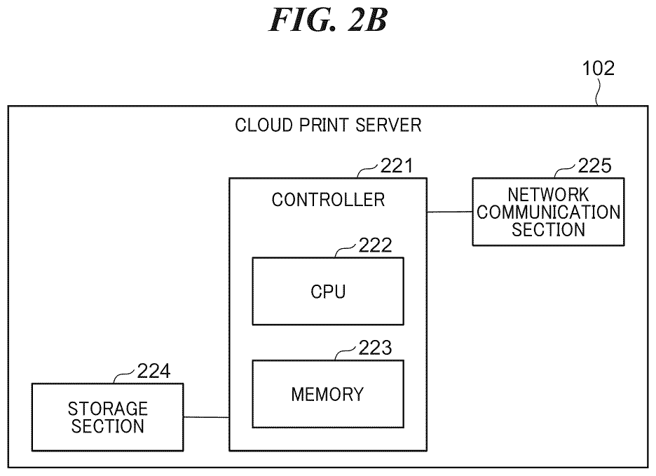

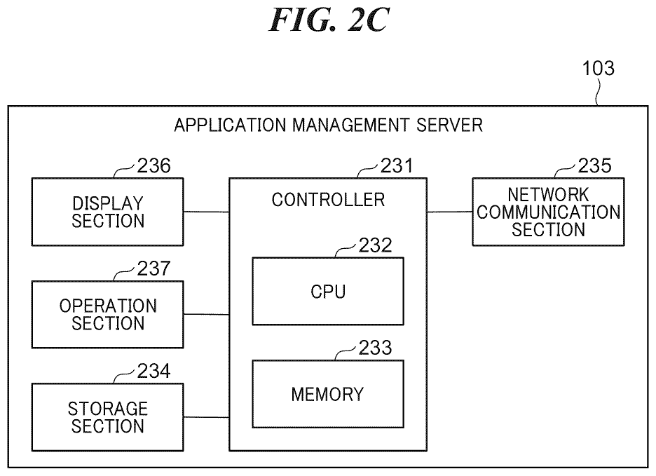

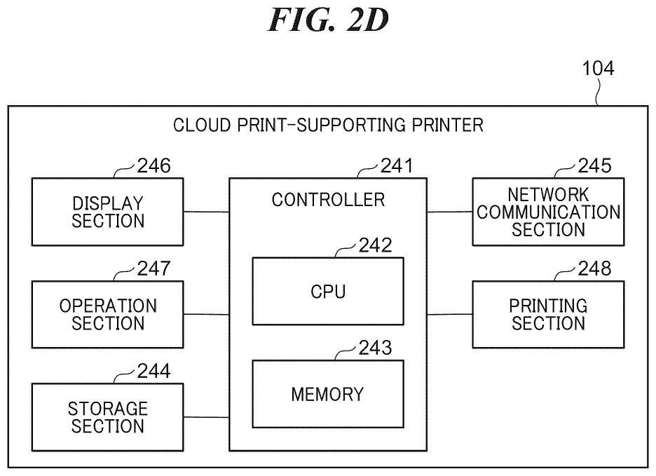

FIGS. 2A to 2D are block diagrams showing examples of hardware configurations of the printing system. FIG. 2A is a block diagram showing an example of a hardware configuration of the client terminal. FIG. 2B is a block diagram showing an example of a hardware configuration of the cloud print server. FIG. 2C is a block diagram showing an example of a hardware configuration of the application management server. FIG. 2D is a block diagram showing an example of a hardware configuration of the printer. The client terminal 101 shown in FIG. 2A is an information processing apparatus including a controller 211, the storage section 214, a network communication section 215, a display section 216, and an operation section 217. The controller 211 is a computer that has a central processing unit (CPU) 212 and a memory 213 and controls the overall operation of the client terminal 101. The controller 211 is capable of executing steps (control method), described hereinafter. The CPU 212 loads programs stored in the storage section 214 into the memory 213 and executes the loaded programs. The memory 213 functions as a main storage memory for the CPU 212 and also functions as a work area and a temporary storage area for loading a variety of programs. The storage section 214 is a nonvolatile storage device, such as a hard disk or a solid state drive (SSD). The storage section 214 stores data. Further, the data stored in the storage section 214 is rewritable. The network communication section 215 transmits and receives data to and from the cloud print server 102, the application management server 103, and the printer 104, via the network 105. The display section 216 is comprised, for example, of a liquid crystal display, and displays a variety of information to a user using the client terminal 101. The operation section 217 is comprised, for example, of a keyboard and a mouse, and receives an input from a user. Note that the client terminal 101 can be equipped with a touch panel having the function of the display section 216 and the function of the operation section 217.

The cloud print server 102 shown in FIG. 2B is an information processing apparatus including a controller 221, a storage section 224, and a network communication section 225. The controller 221 has a CPU 222 and a memory 223. The functions of the controller 221, the storage section 224, and the network communication section 225 are the same as the functions of the controller 211, the storage section 214, and the network communication section 215 of the client terminal 101, respectively. The application management server 103 shown in FIG. 2C is an information processing apparatus including a controller 231, a storage section 234, a network communication section 235, a display section 236, and an operation section 237. The controller 231 has a CPU 232 and a memory 233. The functions of the controller 231, the storage section 234, the network communication section 235, the display section 236, and the operation section 237 are the same as the functions of the controller 211, the storage section 214, the network communication section 215, the display section 216, and the operation section 217 of the client terminal 101, respectively.

The printer 104 shown in FIG. 2D includes a controller 241, a storage section 244, a network communication section 245, a display section 246, an operation section 247, and a printing section 248. The controller 241 has a CPU 242 and a memory 243. The functions of the controller 241, the storage section 244, the display section 246, and the operation section 247 are the same as the functions of the controller 211, the storage section 214, the display section 216, and the operation section 217 of the client terminal 101, respectively. The network communication section 245 transmits and receives data to and from the client terminal 101 and the cloud print server 102 via the network 105. With this, the network communication section 245 can receive print data from the client terminal 101 or transmit information concerning the operation state of the printer 104, such as an error, to the client terminal 101. The printing section 248 performs print processing by executing a series of operations of sheet feeding, printing, and sheet discharging, for a print sheet accommodated in a cassette or set on a tray. The printing method is not particularly limited, and for example, the electrophotographic method or the inkjet method can be used. Note that the printer 104 can include a finishing apparatus that performs stapling, punching, and so forth, on a print sheet subjected to printing.

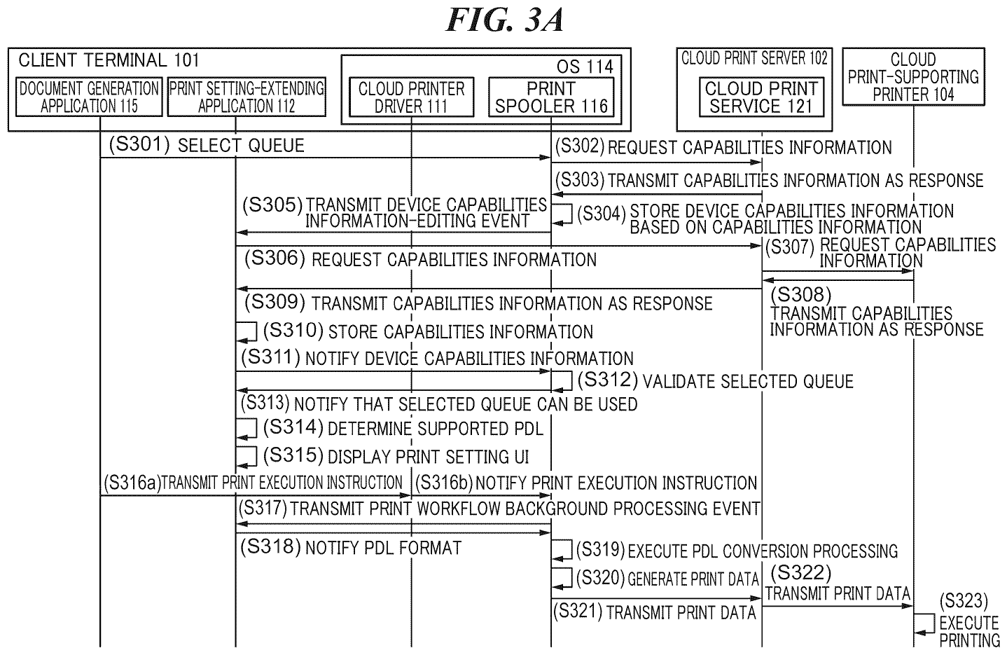

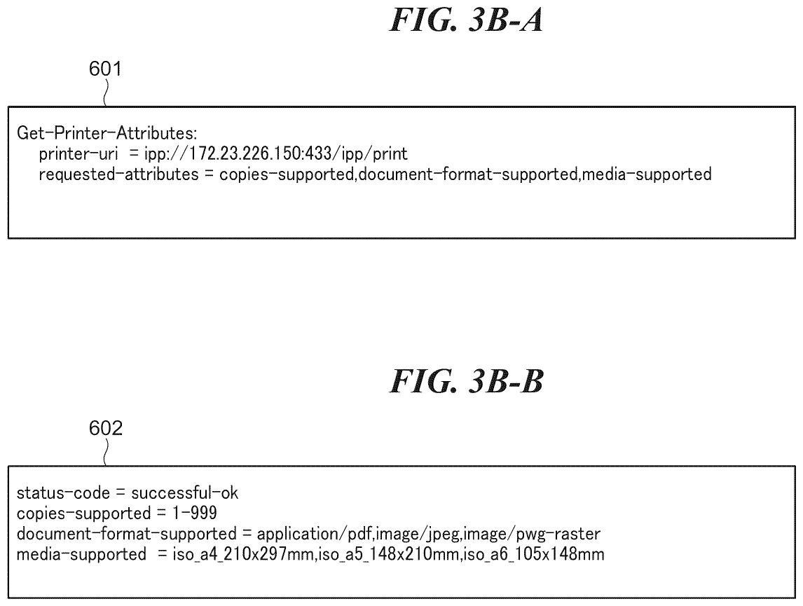

FIG. 3A is a sequence diagram showing a process executed between the client terminal 101, the cloud print server 102, and the printer 104. FIGS. 3B-A and 3B-B are diagrams showing a capabilities information request (Get-Printer-Attributes) provided in a step S302 of the sequence diagram shown in FIG. 3A and IPP attribute information in a capabilities information response transmitted in a step S303 of the same in response to the request, respectively. Note that the process shown in FIG. 3A is executed after the information of the printer 104 is registered in the cloud print service 121 and generation of a print queue is completed. It is assumed here that a print queue to be transmitted to the printer 104 via the cloud print service 121 has already been generated.

Referring to FIG. 3A, in a step S301, the document generation application 115 provides an application print setting UI. Then, the print spooler 116 of the OS 114 receives selection of a print queue on the application print setting UI. Specifically, first, the user using the client terminal 101 starts the document generation application 115 on the client terminal 101. Then, the user opens data (original) to be printed, by using the document generation application 115, and instructs printing of this data. Upon receipt of this print instruction, the document generation application 115 displays the application print setting UI on the display section 216. On the application print setting UI, printer names of printers which can print the data to be printed are displayed. Note that, in the present embodiment, the printer names include the printer name of the printer 104. The user selects this printer name on the application print setting UI. With this, the print spooler 116 determines that a print queue associated with the selected printer name is selected. Note that although, in the present embodiment, selection of a print queue is performed on the application print setting UI provided by the document generation application 115, this is not limitative, but, for example, selection of a print queue can be performed on an OS print setting UI provided by the OS 114. Further, selection of the print queue causes the print spooler 116 to read out a print ticket. The print ticket refers to a file indicating print setting information in which the current print settings are described in the XML format and is managed on a print queue-by-print queue basis. In a print ticket, print settings are described in a format which can be interpreted by the OS 114. The print settings are each described as a set of a setting item and a set value.

In the step S302, the print spooler 116 transmits a request of the capabilities information of the printer associated with the print queue selected in the step S301 (the printer 104 in this example) to the cloud print service 121 of the cloud print server 102. For this request, a capabilities information request command defined by the IPP is used. As an argument of this command, attribute information associated with each setting item is set. With this, it is possible to acquire the capabilities information of the setting items designated by the print spooler 116. Note that the attribute information and the attribute values in the present embodiment are information in compliance with the IPP. In a capabilities information request 601, shown in FIG. 3B-A, the capabilities information of a supported number of copies (copies-supported) is requested to the printer designated by printer-uniform resource identifier (uri). Further, the capabilities information of a supported page description language (PDL)(document-format-supported) and a supported sheet (media-supported) are requested.

In the step S303, the cloud print service 121 transmits the capabilities information of the printer 104 to the print spooler 116 as a response to the request received in the step S302. A capabilities information response 602 shown in FIG. 3B-B is the response to the capabilities information request 601. The capabilities information response 602 includes information that the response is successful (successful-ok) and information that the number of copies can be designated from one copy to 999 copies (1-999). There is also included information that the supported PDLs are portable document format (PDF) (application/pdf), Joint Photographic Experts Group (JPEG) (image/jpeg), and Printer Working Group (PWG)-Raster (image/pwg-raster) are supported. Further included is information that the supported sheets are A4, A5, and A6.

In a step S304, the print spooler 116 stores the capabilities information of the printer 104, which has been transmitted in the step S303, as the device capabilities information associated with the print queue of the printer 104.

In a step S305, the print spooler 116 transmits an event indicating that the device capabilities information stored in the step S304 can be edited (device capabilities information-editing event) to the device capabilities collection processor 112b of the print setting-extending application 112.

In a step S306, when the device capabilities information-editing event transmitted in the step S305 is received, the device capabilities collection processor 112b requests the capabilities information of the printer 104 to the cloud print service 121. Specifically, the device capabilities collection processor 112b requests the attribute information selected as a request target to the cloud print service 121 by using a standard protocol defined by the IPP. Note that the print setting-extending application 112 can also acquire the capabilities information with respect to attribute information not supported by the OS 114. In the present embodiment, the attribute information specific to the printer vendor is set as an argument of the protocol used for the request in the step S306. With this, the capabilities information can also be acquired with respect to the attribute information which is not defined by the IPP. Further, the device capabilities collection processor 112b is enabled to use an application programming interface (API) of the OS 114 at a time when the device capabilities information-editing event is received. By using the API, editing of the device capabilities information is enabled.

In a step S307, the cloud print service 121 requests the capabilities information by using the IPP to the printer 104 according to the capabilities information request received in the step S306. Specifically, the cloud print service 121 inquires the printer 104 of the capabilities information of the printer 104 by using the argument notified from the client terminal 101.

In a step S308, the printer 104 transmits the capabilities information of the printer 104 to the cloud print service 121 in response to the request received in the step S307.

In a step S309, the cloud print service 121 transmits the capabilities information of the printer 104, which has been received in the step S308, to the print setting-extending application 112.

In a step S310, the print setting-extending application 112 duplicates and stores the capabilities information acquired by the client terminal 101 in the processing operations up to the step S310 in a data storage area of the print setting-extending application 112 as the device capabilities information data. Thus, the capabilities information is acquired (acquisition step). Note that this acquisition step is performed before a display control step, described hereinafter.

In a step S311, the print setting-extending application 112 transmits the device capabilities information data stored in the step S310 to the print spooler 116.

In a step S312, when the device capabilities information data transmitted in the step S311 is received, the print spooler 116 validates the print queue selected in the step S301. With this, the print setting UI section 112a of the print setting-extending application 112 can be started.

In a step S313, the print spooler 116 transmits a notification that the print queue validated in the step S312 can be used, to the print setting-extending application 112. When the print setting-extending application 112 receives this notification, the document generation application 115 places a details setting button and a print button, included in the application print setting UI being displayed, in a selectable state. Note that in a case where the OS print setting UI is displayed in place of the application print setting UI, a details setting button and a print button of a print dialog, included in this OS print setting UI, are placed in a selectable state. Then, when the details setting button is selected, the print setting UI section 112a is started. Note that the operation for starting the print setting UI section 112a is not limited to the operation of selecting the details setting button but can be e.g. an operation of selecting a button other than the details setting button, which is included in the application print setting UI.

In a step S314, the print setting-extending application 112 determines the PDL format supported by the printer 104 based on the device capabilities information data stored in the step S310.

In a step S315, the print setting-extending application 112 displays the print setting UI 112d according to a result of the determination in the step S314 on the display section 216.

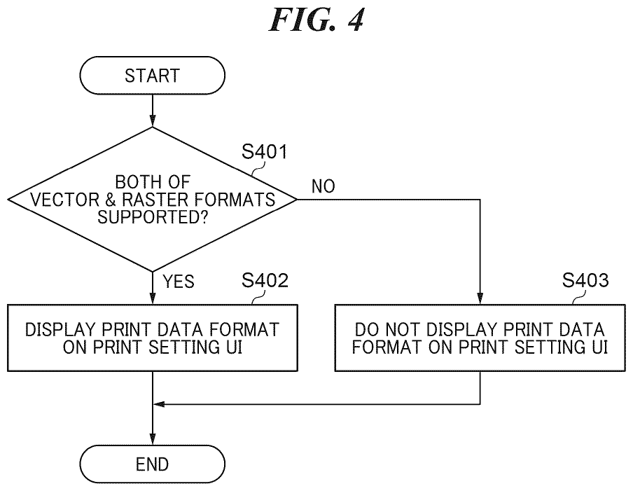

Here, details of the processing operations in the steps S314 and S315 will be described with reference to FIGS. 4 and 5A to 5C. FIG. 4 is a flowchart showing details of the processing operations in the steps S314 and S315 of the sequence diagram shown in FIG. 3A. FIGS. 5A to 5C are diagrams each showing an example of a screen displayed on the client terminal. FIG. 5A is a diagram showing an example of a print settings screen on which the print data format can be set. FIG. 5B is a diagram showing an example of a print settings screen from which a print data format-setting section 510 is omitted. FIG. 5C is a diagram showing a selection state of the print data format setting on the print settings screen shown in FIG. 5A. Referring to FIG. 4, in a step S401, the print setting-extending application 112 determines based on the device capabilities information data stored in the step S310 whether or not the printer 104 supports both of the vector format and the raster format as the supported PDL. For example, in a case where the capabilities information is the capabilities information response 602 (see FIG. 3B-B), PDF is the vector format, and JPEG and PWG-Raster are the raster formats. The information of PDF, JPEG, and PWG-Raster, included in the capabilities information response 602, is information for determining whether or not to enable a print settings screen (setting reception screen) 501, shown in FIG. 5A, to be displayed (determination step). In a case where PDF, JPEG, and PWG-Raster are included in the capabilities information response 602, it is determined that the print settings screen 501 can be displayed, whereas in a case where these are not included, it is determined that the print settings screen 501 cannot be displayed. Then, if it is determined in the step S401 that both of the PDLs are supported, the process proceeds to a step S402. On the other hand, if it is determined in the step S401 that both of the PDLs are not supported, the process proceeds to a step S403.

In the step S402, the print setting UI section 112a of the print setting-extending application 112 displays the print settings screen 501 (see FIG. 5A) as the print setting UI 112d (display control step). After execution of the step S402, the present process is terminated.

In the step S403, the print setting UI section 112a of the print setting-extending application 112 does not display the print settings screen 501 as the print setting UI 112d but displays a print settings screen 502 (see FIG. 5B) instead of the print settings screen 501. After execution of the step S403, the present process is terminated.

As shown in FIG. 5A, the print settings screen 501 includes the print data format-setting section 510, an output sheet size-setting section (size setting section) 511, a sheet type-setting section (type setting section) 512, a number-of-copies setting section 513, and a single-sided/double-sided setting section (printing surface-setting section) 514. Further, the print settings screen 501 further includes an OK button 515, a cancel button 516, and a print state simulation image 517. In the print data format-setting section 510, it is possible to receive a setting of the print data format. The print data format-setting section 510 in a print data format-setting screen 503 shown in FIG. 5C includes a first setting section 510a and a second setting section 510b, and one of these setting sections can be selected. Then, in a case where the first setting section 510a is selected, the print data format can be set to the vector format. On the other hand, in a case where the second setting section 510b is selected, the print data format can be set to the raster format. Thus, on the print settings screen 501, it is possible to set the print data format to a desired one of the vector format and the raster format. Note that the function of receiving a print data format setting is a function which cannot be executed by the cloud printer driver 111 (the local printer driver 113 as well) which is the standard driver. Therefore, in the client terminal 101, a print data format setting can be received by the print setting-extending application 112. Further, as shown in FIG. 5A, in a state in which neither of the first setting section 510a nor the second setting section 510b is selected, the first setting section 510a is displayed preferentially to the second setting section 510b. That is, in the print data format-setting section 510, the first setting section 510a is displayed in the default state. This is because, for example, the client terminal 101 executes not only the processing related to printing, but also a variety of processing operations, and hence it is desired to prompt a user to select, if possible, the vector format, which is relatively low in load of processing print data. Further, when transmitting print data from the client terminal 101, the print data of the vector format can be made smaller in volume than the print data of the raster format.

In the output sheet size-setting section 511, the size of a print sheet used for printing can be set to e.g. an A4 size. In the sheet type-setting section 512, the type of a print sheet used for printing can be set to e.g. plain paper. In the number-of-copies setting section 513, the number of copies to be printed can be set to e.g. one copy. In the single-sided/double-sided setting section 514, whether printing is to be performed on a single side or on double sides can be set. Note that although the print settings screen 501 includes the output sheet size-setting section 511 to the single-sided/double-sided setting section 514, this is not limitative, but at least one of these can be included. Further, by operating the OK button 515, the setting states in the print data format-setting section 510 to the single-sided/double-sided setting section 514 are reflected on the print data (print job), and the process in FIG. 3A proceeds to a step S316a. On the other hand, by operating the cancel button 516, the setting states in the print data format-setting section 510 to the single-sided/double-sided setting section 514 are canceled, and the print instruction is cancelled. The print state simulation image 517 is a simulation image on which the setting states in the print data format-setting section 510 to the single-sided/double-sided setting section 514 are reflected. Note that the print state simulation image 517 is an image different from a preview image.

As shown in FIG. 5B, the print settings screen 502 is a screen from which the print data format-setting section 510 is omitted, differently from the print settings screen 501. As described above, the print settings screen 502 is displayed in a case where it is determined in the step S401 that neither of the PDLs is supported.

As shown in FIG. 3A, in a case where the print instruction is finalized on the application print setting UI by operation of the OK button 515 on the print settings screen 501 or 502 in the step S315, the document generation application 115 transmits a print execution instruction including the data to be printed to the cloud printer driver 111 in a step S316a.

In a step S316b, when the print execution instruction transmitted in the step S316a is received, the cloud printer driver 111 notifies the print spooler 116 that the print execution instruction has been received.

In a step S317, when the notification transmitted in the step S316b is received, the print spooler 116 transmits a print workflow background processing event to the print setting-extending application 112. By transmitting the print workflow background processing event, it is possible to start the print workflow background processing performed by the print setting-extending application 112. The print workflow background processing refers to processing for providing an instruction from the print setting-extending application 112 to the cloud printer driver 111 via the print spooler 116. Further, the print spooler 116 receives data (e.g. image data of the graphic device interface (GDI) format) from the document generation application 115 via the cloud printer driver 111. The print spooler 116 can generate intermediate image data from this data or alternatively convert this data to PDL. The intermediate image data refers to e.g. X-ray Photoelectron Spectroscopy (XPS) data generated before converting the data to print data, such as PDL data.

In a step S318, the print setting-extending application 112 notifies the print spooler 116 of the PDL format. At this time, in a case where the print settings screen 501 is displayed as the print setting UI 112d, the PDL format to be notified to the print spooler 116 is switched according to the setting set in the print data format-setting section 510. For example, in a case where the first setting section 510a is selected and set in the print data format-setting section 510, PDF is notified. Further, in a case where the second setting section 510b is selected and set in the print data format-setting section 510, JPEG or PWG-Raster is notified. Note that in a case where the print settings screen 502 is displayed as the print setting UI 112d, the PDL format to be notified to the print spooler 116 is not switched.

In a step S319, the print spooler 116 converts the intermediate image data generated in the step S317 to the PDL format which is the print data format notified in the step S318.

In a step S320, the print spooler 116 generates print data for transmitting the PDL data converted in the step S319 to the printer 104 using the IPP. That is, the print spooler 116 generates the print data according to the setting of the format received on the print settings screen 501 (generation control step).

In a step S321, the print spooler 116 transmits the print data generated in the step S320 to the cloud print service 121 via the print queue received in the step S301 (transmission control step).

In a step S322, the cloud print service 121 transmits the print data transmitted in the step S321 to the printer 104.

In a step S323, the printer 104 prints the print data transmitted in the step S322. Note that although the print data generated by the cloud printer driver 111 (the print spooler 116) is transmitted to the printer 104 via the cloud print service 121 in the present embodiment, this is not limitative. In a case where print data is generated by the local printer driver 113, this print data is directly transmitted to the printer 104 not via the cloud print service 121. Further, in the client terminal 101, print data not based on execution of the print setting-extending application 112 can also be generated.

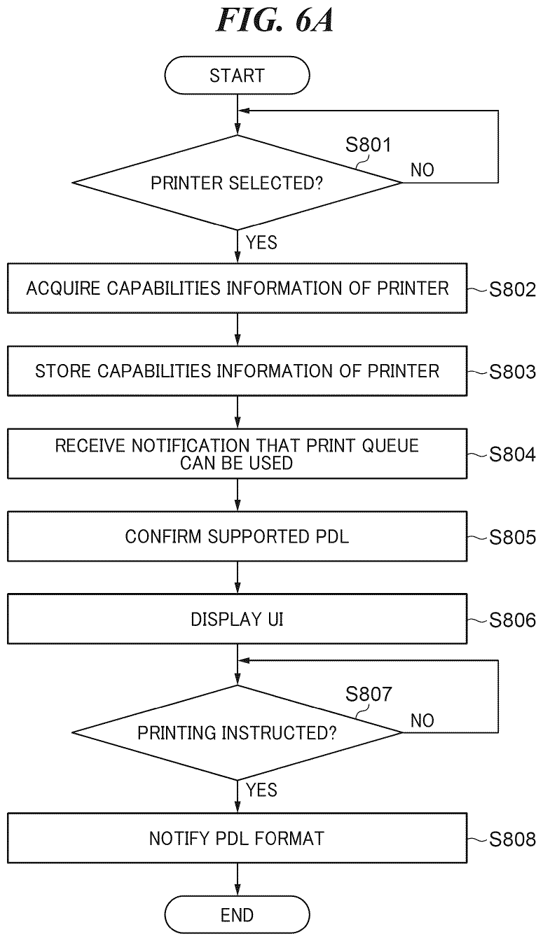

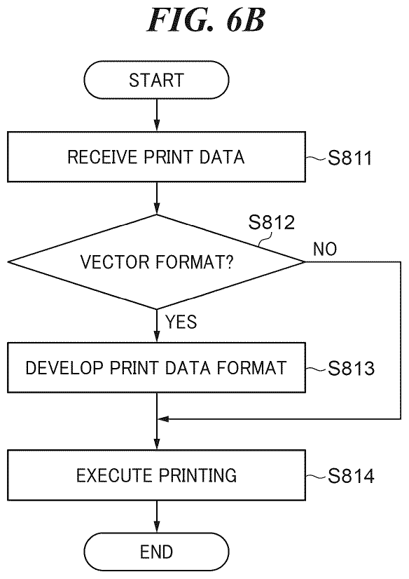

FIG. 6A is a flowchart of a process executed by the client terminal 101. Referring to FIG. 6A, in a step S801, the CPU 212 of the client terminal 101 executes the print setting-extending application 112 to receive the event notification from the OS 114 (see the step S305), and determines, based on the event notification, whether or not the printer 104 (device) to be used for printing has been selected. If it is determined in the step S801 that the printer 104 has been selected, the process proceeds to a step S802. On the other hand, if it is determined in the step S801 that the printer 104 has not been selected, the process remains in the step S801.

In the step S802, the CPU 212 executes the print setting-extending application 112 to acquire the capabilities information of the printer 104 by the device capabilities collection processor 112b (see the step S309).

In a step S803, the CPU 212 executes the print setting-extending application 112 to store the capabilities information of the printer 104, which has been acquired in the step S802, in the device capabilities collection processor 112b (the step S310).

In a step S804, the CPU 212 executes the print setting-extending application 112 to receive the notification indicating that the print queue of the printer 104 can be used, from the print spooler 116 (see the step S313).

In a step S805, the CPU 212 executes the print setting-extending application 112 to confirm the PDL which can be supported by the printer 104 (see the step S314).

In a step S806, the CPU 212 executes the print setting-extending application 112 to display the print setting UI 112d (see the step S315).

In a step S807, the CPU 212 executes the print setting-extending application 112 to receive the event notification from the OS 114 (see the step S317). The CPU 212 determines, based on this event notification, whether or not printing has been instructed to the printer 104. If it is determined in the step S807 that printing has been instructed, the process proceeds to a step S808. On the other hand, if it is determined in the step S807 that printing has not been instructed, the process remains in the step S807.

In the step S808, the CPU 212 executes the print setting-extending application 112 to notify the print spooler 116 of the PDL format. Then, the print spooler 116 generates print data according to the notification from the print setting-extending application 112 (see the step S320). This print data is transmitted to the printer 104 via the cloud print service 121 (see the steps S321 and S322). After the step S808, the present process is terminated.

FIG. 6B is a flowchart of a process executed by the printer 104. Referring to FIG. 6B, in a step S811, the CPU 242 of the printer 104 receives the print data transmitted in the step S808 in FIG. 6A via the network communication section 215.

In a step S812, the CPU 242 determines whether or not the format of the print data received in the step S811 is the vector format. If it is determined in the step S812 that the format of the print data is the vector format, the process proceeds to a step S813. On the other hand, if it is determined in the step S812 that the format of the print data is not the vector format, i.e. the format is the raster format, the process proceeds to a step S814.

In the step S813, the CPU 242 develops the format of the print data received in the step S811 into the raster format.

In the step S814, the CPU 242 prints the print data (see the step S323).

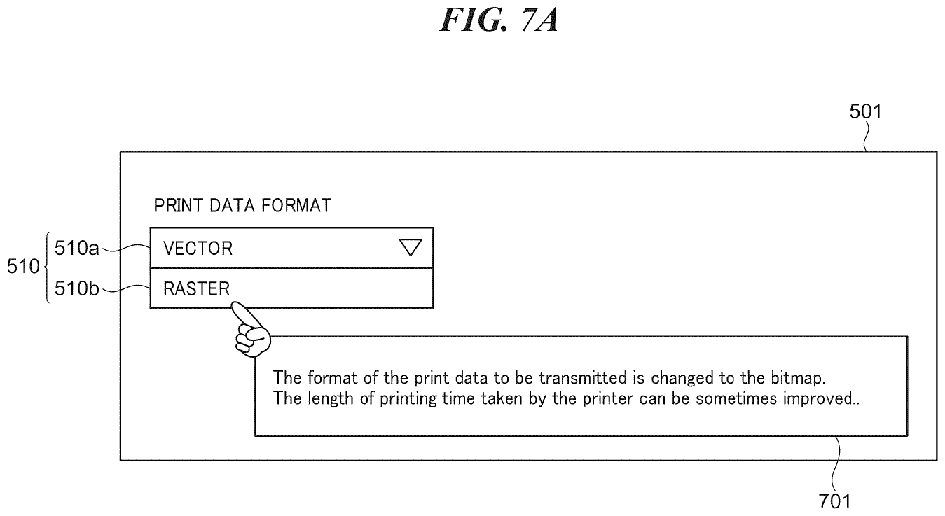

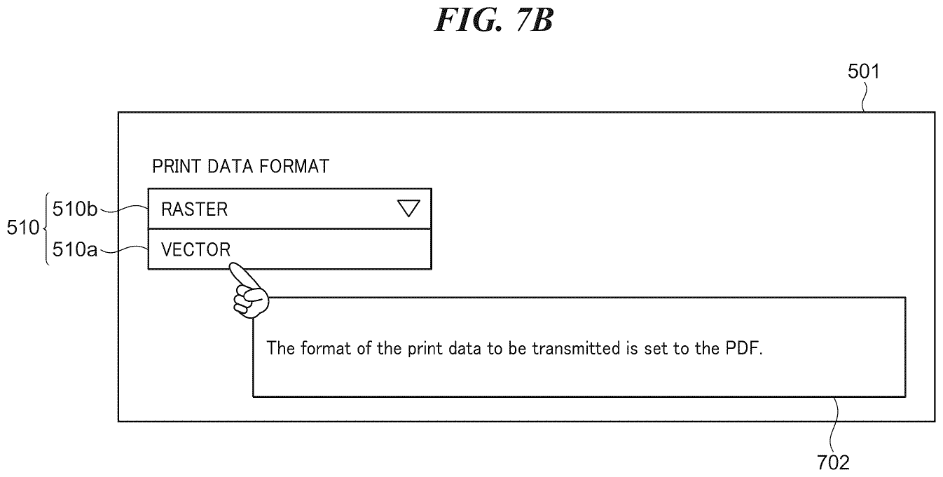

A second embodiment will be described below with reference to FIGS. 7A and 7B, but the description will be given mainly of different points from the above-described first embodiment, and description of the same points is omitted. FIGS. 7A and 7B are diagrams each showing an example of a screen displayed on the client terminal 101 according to the second embodiment. FIG. 7A is a diagram showing an example of the print settings screen in a state in which the format of the print data is set to the raster format. FIG. 7B is a diagram showing an example of the print settings screen in a state in which the format of the print data is set to the vector format. The print settings screen 501 shown in FIG. 7A is in a state in which the second setting section 510b is selected and set in the print data format-setting section 510. This print settings screen 501 includes a message (description) 701 about a result obtained by selecting the second setting section 510b, i.e. by setting the raster format. The message 701 is, for example, “The format of the print data to be transmitted is changed to the bitmap. The length of printing time taken by the printer can be sometimes improved.”. The print settings screen 501 shown in FIG. 7B is in a state in which the first setting section 510a is selected and set in the print data format-setting section 510. This print settings screen 501 includes a message 702 about a result obtained by selecting the first setting section 510a, i.e. by setting the vector forma. The message 702 is, for example, “The format of the print data to be transmitted is set to the PDF”. Note that the message 702 can be, for example, “In general, it is sometimes possible to obtain a print result having higher image quality by setting the format to the PDF.”, “It is possible to reduce the processing required to be performed by the client terminal 101.”, and/or “It is possible to reduce the volume of the print data to be transmitted.”. With the message 701 or 702, it is possible to grasp a result to be obtained by the selected format.

The present disclosure has been described heretofore based on the embodiments thereof. However, the present disclosure is not limited to these embodiments, but it is to be understood that the disclosure includes various variations and modifications within the scope of the gist of the present disclosure. Although as the print data format, the vector format and the raster format are mentioned in the above-described embodiments, this is not limitative. For example, as the other print data formats, a variety of formats including photoshop document (PSD), scalable vector graphics (SVG), and the like can be used Further, in the client terminal 101, the format of print data generated by the standard driver can be further changed by the print setting-extending application 112 (format changing control step). Then, the print data, the format of which has been changed by the print setting-extending application 112, is transmitted to the printer 104.

According to the present disclosure, it is possible to set the print data format as desired.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-160613, filed Sep. 18, 2024, which is hereby incorporated by reference herein in its entirety.

What is claimed is:

1. A non-transitory computer-readable storage medium storing an application program supporting a standard driver that is provided from a provider of an operating system and is incorporated in the operating system in advance, the application program causing a computer to:
display a setting reception screen for receiving a setting of a format of print data; and
cause the standard driver to generate the print data, with the setting of the format, which has been received on the setting reception screen.

2. The storage medium according to claim 1, wherein on the setting reception screen, a setting of whether the format of the print data is set to a vector format or a raster format is received.

3. The storage medium according to claim 2, wherein the setting reception screen includes a first setting section for setting the format of the print data to the vector format and a second setting section for setting the format of the print data to the raster format, and one of the first setting section and the second setting section can be selected.

4. The storage medium according to claim 3, wherein in a state in which neither of the setting sections is selected, the first setting section is displayed on the setting reception screen preferentially to the second setting section.

5. The storage medium according to claim 3, wherein in a state in which the one setting section is selected, the setting reception screen includes description concerning a result to be obtained by selecting the one setting section.

6. The storage medium according to claim 1, wherein the setting reception screen includes at least one of a size setting section for setting a size of a print sheet to be used for printing, a type setting section for setting a type of a print sheet to be used for the printing, a number-of-copies setting section for setting the number of copies of the printing, and a printing surface-setting section for setting whether the printing is to be performed on a single side or both sides.

7. The storage medium according to claim 1, wherein the application program causes the computer to:
acquire, from a printing apparatus, capabilities information related to capabilities of the printing apparatus for performing printing, before causing the setting reception screen to be displayed, and
determine whether or not information which enables display of the setting reception screen is included in the acquired capabilities information, and
wherein before displaying the setting reception screen, in a case where it is determined that the information which enables display of the setting reception screen is included, the setting reception screen is displayed, whereas in a case where it is determined that the information which enables display of the setting reception screen is not included, the setting reception screen is not displayed.

8. The storage medium according to claim 7, wherein the application program causes the computer to cause the standard driver to transmit the print data generated to the printing apparatus.

9. The storage medium according to claim 8, wherein the printing apparatus is capable of printing the print data transmitted.

10. The storage medium according to claim 1, wherein the application program causes the computer to further change the format of the print data generated by the standard driver.

11. The storage medium according to claim 1, wherein a function of receiving the format setting is a function which cannot be executed by the standard driver.

12. The storage medium according to claim 1, wherein, as the standard driver, a program operating based on the Internet Printing Protocol (IPP) is used.

13. An information processing apparatus including a standard driver that is provided from a provider of an operating system and is incorporated in the operating system in advance, and an application program supporting the standard driver,
the application program causing a computer of the information processing apparatus to:
display a setting reception screen for receiving a setting of a format of print data; and
cause the standard driver to generate the print data, with the setting of the format, which has been received on the setting reception screen.

14. A method of performing control to support a standard driver that is provided from a provider of an operating system and is incorporated in the operating system in advance, comprising:
displaying a setting reception screen for receiving a setting of a format of print data; and
causing the standard driver to generate the print data, with the setting of the format, which has been received on the setting reception screen.
